(19) United States
(12) Patent Application Publication
(10) Pub. No.: US 2024/0359616 A1
(43) Pub. Date: Oct. 31, 2024

(54) FLATBED TRUCK WITH NOVEL DECK ASSEMBLY

(71) Applicant: David A. Jaeger, Oregon, OH (US)

(72) Inventor: David A. Jaeger, Oregon, OH (US)

(21) Appl. No.: 18/648,794

(22) Filed: Apr. 29, 2024

Related U.S. Application Data
(60) Provisional application No. 63/498,867, filed on Apr. 28, 2023.

(51) Int. Cl. B60P 3/073

(52) U.S. Cl. CPC B60P 3/073

(57) ABSTRACT

A deck assembly configured for use in a flatbed truck is provided. The deck assembly includes a deck body having an upper surface, an opposing lower surface, a first end and an opposing second end. A plurality of longitudinal slots extend from the upper surface of the deck body into the deck body. A plurality of conveyance assemblies are positioned in each of the longitudinal slots. Each of the plurality of conveyance assemblies has a plurality of conveyance mechanisms configured to facilitate movement of a wheel of a recovered vehicle in a direction along the longitudinal slot.

### RELATED APPLICATIONS

This invention claims the benefits of pending U.S. Provisional Patent Application No. 63/498,867, filed Apr. 28, 2023. The entire disclosure of this application is incorporated herein by reference.

### FIELD

This invention is directed to flatbed trucks and more particularly, to flatbed trucks used to haul vehicles.

### INTRODUCTION

This section provides background information related to the present disclosure which is not necessarily prior art.

Flatbed trucks are known to include a deck configured to receive a vehicle for purposes of hauling the vehicle from one location to another location. Typically, the vehicle is pulled onto the deck by a winch. Subsequently, the vehicle is secured to the deck for purposes of transporting the vehicle. In certain embodiments, the deck can move and rotate to facilitate loading of the vehicle onto the deck and offloading the vehicle from the deck.

In certain instances, the wheels of the vehicle being transported may not rotate, thereby causing difficulty in pulling the vehicle onto the deck or offloading the vehicle from the deck.

Therefore, it would be advantageous to equip the deck of a flatbed truck with apparatus configured to facilitate loading of the vehicle onto the deck or offloading the vehicle from the deck in the event the wheels of the vehicle do not rotate or have difficulty rotating.

### SUMMARY

It should be appreciated that this Summary is provided to introduce a selection of concepts in a simplified form, the concepts being further described below in the Detail Description. This Summary is not intended to identify key features or essential features of this disclosure, nor is it intended to limit the scope of the flatbed truck with a novel deck assembly.

The above objects as well as other objects not specifically enumerated are achieved by a deck assembly configured for use in a flatbed truck. The deck assembly includes a deck body having an upper surface, an opposing lower surface, a first end and an opposing second end. A plurality of longitudinal slots extend from the upper surface of the deck body into the deck body. A plurality of conveyance assemblies are positioned in each of the longitudinal slots. Each of the plurality of conveyance assemblies has a plurality of conveyance mechanisms configured to facilitate movement of a wheel of a recovered vehicle in a direction along the longitudinal slot.

The above objects as well as other objects not specifically enumerated are also achieved by a method of forming a deck assembly for use in a flatbed truck. The method includes the steps of forming a deck body having an upper surface, an opposing lower surface, a first end and an opposing second end, extending a plurality of longitudinal slots from the upper surface of the deck body into the deck body and positioning a plurality of conveyance assemblies in the longitudinal slots, each of the plurality of conveyance assemblies having a plurality of conveyance mechanisms configured to facilitate movement of a wheel of a recovered vehicle in a direction along the longitudinal slot.

The above objects as well as other objects not specifically enumerated are also achieved by a flatbed truck configured to transport a recovered vehicle. The flatbed truck includes a deck assembly supported by a vehicle frame. The deck assembly has a deck body having an upper surface, an opposing lower surface, a first end and an opposing second end. The deck body has a plurality of longitudinal slots extending from the upper surface of the deck body into the deck body. A plurality of conveyance assemblies are positioned in the longitudinal slots. Each of the plurality of conveyance assemblies has a plurality of conveyance mechanisms configured to facilitate movement of a wheel of a recovered vehicle in a direction along the longitudinal slot.

Further areas of applicability will become apparent from the description provided herein. The description and specific examples in this Summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a conventional flatbed truck equipped with a novel deck assembly in according with the invention.

FIG. 2 is a side view of the flatbed truck equipped with novel deck assembly of FIG. 1, illustrating loading of a recovered vehicle.

FIG. 3 is a side view of the flatbed truck equipped with novel deck assembly of FIG. 1, illustrating a loaded, recovered vehicle.

FIG. 4 is a plan view of a deck assembly of the flatbed truck of FIG. 1, illustrating a plurality of conveyance assemblies.

FIG. 5 is an end view of the deck assembly of the flatbed truck of FIG. 4, illustrating a first embodiment of the position of the conveyance mechanisms relative to the deck assembly.

FIG. 6 is an end view of the deck assembly of the flatbed truck of FIG. 4, illustrating a second embodiment of the position of the conveyance mechanisms relative to the deck assembly.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The features of the invention will be more readily understood by referring to the attached drawings in connection with the following descriptive material.

Referring now to the Figures and in accordance with the illustrated embodiments of the present disclosure, a flatbed truck equipped with a novel deck assembly is provided. The novel deck assembly includes a plurality of conveyance assemblies configured to facilitate movement of a recovered vehicle along the deck assembly in a direction toward or away from a headboard frame in the event the wheels of the recovered vehicle may not rotate or experience difficulty rotating. In certain embodiments, each of the plurality of conveyance assemblies have conveyance mechanisms in the form of rollers. In other embodiments, the plurality of conveyance assemblies have conveyance mechanisms having other forms, including the non-limiting examples of roller wheels or roller balls. Still other embodiments provide a plurality of conveyance assemblies having a mix of conveyance mechanisms within. In certain embodiments, the conveyance mechanisms are positioned within a longitudinal slot and the edges of the longitudinal slot are configured to retain the wheels of the recovered vehicle along the path of the conveyance assembly. In other embodiments, portions of the conveyance mechanisms are positioned above the longitudinal slot and additional structures are used to maintain the wheels of the recovered vehicle along the path of the conveyance assembly.

Referring now to FIG. 1, a conventional flatbed truck is shown generally at 10. As is known in the art, the flatbed truck 10 is configured to load and transport recovered vehicles from one location to another location. The flatbed truck 10 includes a vehicle frame 12 configured to support ground-engaging front wheels 14a and rear wheels 14b for rotation. The vehicle frame 12 is further configured to support an operator cab 16 and a power source, such as the non-limiting example of an engine (not shown), typically located under the operator cab 16. The flatbed truck 10 is equipped with novel deck assembly 20 in accordance with the invention.

Referring again to FIG. 1, the vehicle frame 12 further supports the novel deck assembly 20. The deck assembly 20 is configured for movement in a manner to facilitate loading and offloading of a recovered vehicle. The deck assembly 20 includes an upper surface 22, a lower surface 24, a deck body 26 extending therebetween, a first end 32 and an opposing second end 36. The upper surface 22 is configured for contact with the wheels of the recovered vehicle and the lower surface 24 is configured to seat against the frame 12. In certain embodiments, optionally, the deck assembly 20 can include a headboard frame 30 located at the first end 32. The headboard frame 30 is configured to protect a loaded, recovered vehicle in the instance of a sudden stop. However, it should be appreciated that the headboard frame 30 is optional and not required for successful practice of the novel deck assembly 20.

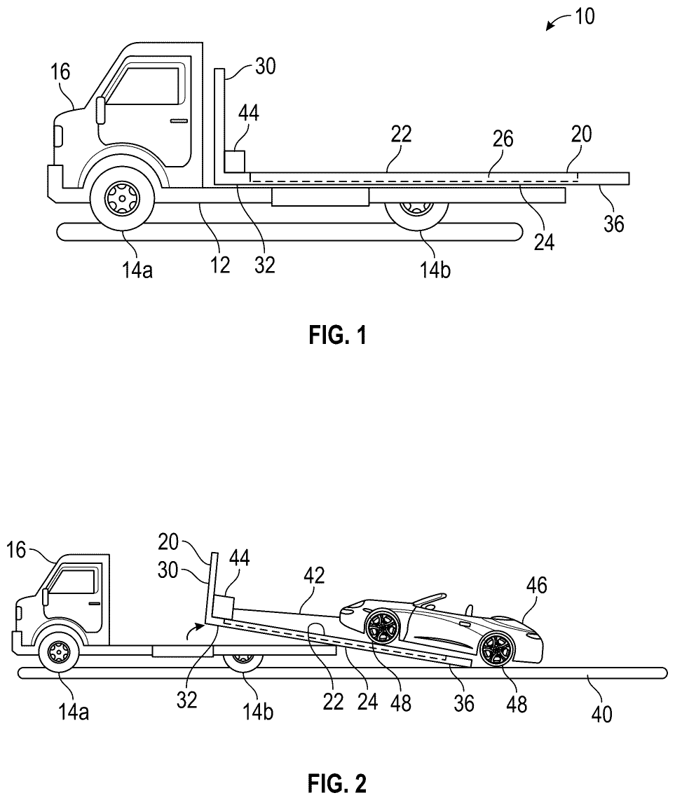

Referring now to FIG. 2, the flatbed truck 10 is illustrated in a loading or offloading orientation. In the loading or offloading orientation, the novel deck assembly 20 moves axially along the frame 12 and tilts in a manner such that the second end 36 seats against a ground surface 40, thereby forming a ramp structure. A line 42 extends from the winch 44 and is connected to a recovered vehicle 46. While the embodiment shown in FIG. 2 illustrates the line 42 as connecting to a front end of the recovered vehicle 46, it should be appreciated that in other embodiments, the line 42 can be connected to other portions of the recovered vehicle 46. As the winch reels in, or reels out, the line 42, wheels 48 of the recovered vehicle 46 rotate, thereby facilitating movement of the recovered vehicle 46 along the deck assembly 20 in a direction toward the headboard frame 30.

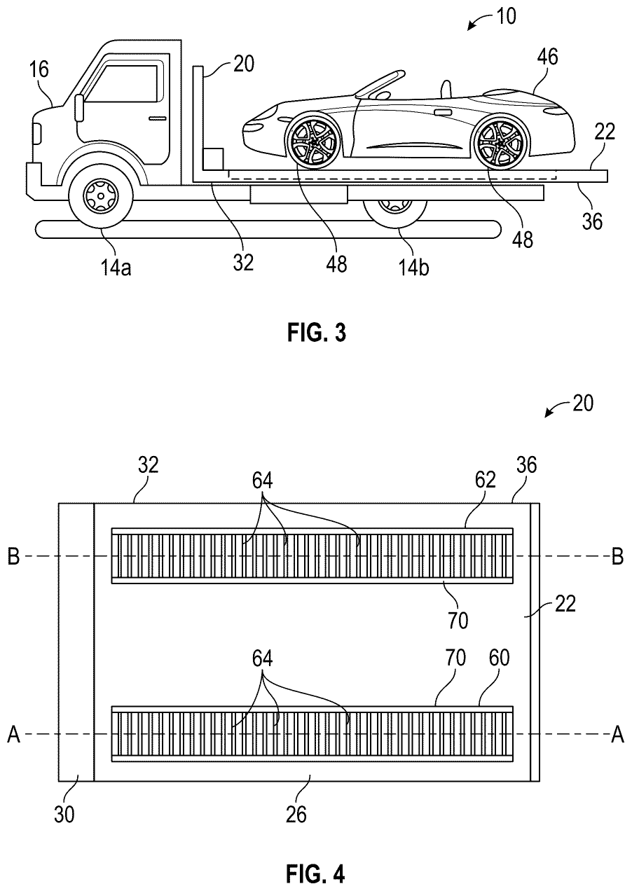

Referring now to FIG. 3, the flatbed truck 10 is shown in a loaded orientation. In the loaded orientation, the deck assembly 20 is returned to its original, substantially horizontal position on the frame 12 and the wheels 48 of the recovered vehicle 46 are positioned in contact with the upper surface 22 of the deck assembly 20. The recovered vehicle 46 is secured to the deck assembly 20 with suitable apparatus (not shown), such as the non-limiting examples of straps and tie-downs.

In certain embodiments, the wheels 48 of the recovered vehicle 46 may not rotate due to many causes including the non-limiting examples of vehicle design, damage to the wheels, damage to the wheel axles and the like. In such instances, pulling of the vehicle 46 onto the deck assembly 20, or offloading the recovered vehicle 46, may require dragging of the recovered vehicle 46 in a skidding manner, which can result in damage to the recovered vehicle 46.

Referring now to FIG. 4, the novel deck assembly 20 is illustrated. The novel deck assembly 20 is configured to facilitate movement of the recovered vehicle 46 along the upper surface 22 of the deck assembly 20 in the event the wheels of the recovered vehicle 46 may not rotate or have difficulty rotating. The novel deck assembly includes the deck body 26, the first end 32, the second end 36 and an optional headboard frame 30. The novel deck assembly 20 further includes a first conveyance assembly 60 and a second conveyance assembly 62. The first conveyance assembly 60 is configured to receive a front and rear wheel on one side of the recovered vehicle 46, such as the driver side. The second conveyance assembly 62 is configured to receive a front and rear wheel on the opposing side of the recovered vehicle 46. It should be appreciated that taken together, the first and second conveyance assemblies 60, 62 are configured to receive the wheels of the recovered vehicle 46.

Referring again to FIG. 4, each of the first and second conveyance assemblies 60, 62 includes a plurality of conveyance mechanisms 64. The term “conveyance mechanism,” as used herein, is defined to mean any mechanism and/or device configured to facilitate movement across its surface. Each of the conveyance mechanisms 64 is arranged to facilitate movement of the recovered vehicle 46 in a direction toward, or away from, the headboard frame 30. The first conveyance assembly 60 has a longitudinal axis A-A and the second conveyance assembly 62 has a longitudinal axis B-B. The longitudinal axis A-A and B-B of the first and second conveyance assemblies 60, 62 are arranged in a longitudinally parallel arrangement.

Referring again to FIG. 4, each of the conveyance mechanisms 64 of the first and second conveyance assemblies 60, 62 are configured to facilitate movement of the recovered vehicle 46 along the deck assembly 20 in a direction toward, or away from the headboard frame 30 in the event the wheels 48 of the recovered vehicle 46 may not rotate or experience difficulty rotating.

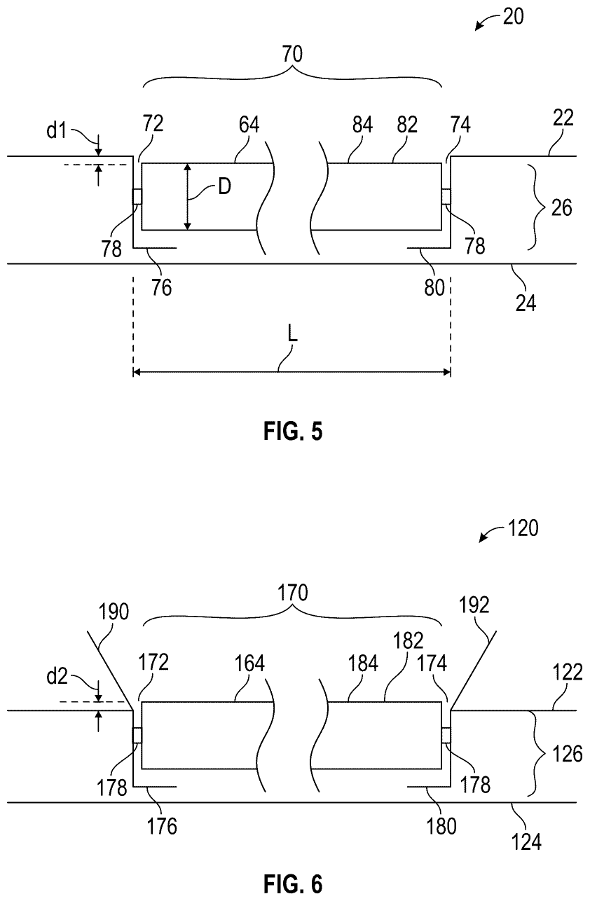

Referring now to FIG. 5, a portion of the novel deck assembly 20 is illustrated. The deck assembly 20 includes the upper surface 22, the lower surface 24 and the deck body 26. A longitudinal slot 70 is formed in the upper surface 22 and the deck body 26. The longitudinal slot 70 extends from the first end 32 of the deck assembly 20 to the second end 36 of the deck assembly and forms a first slot side 72 and a second slot side 74. A first framework rail 76 extends the length of the longitudinal slot 72 and is configured to support an end of an axle 78 supporting a conveyance mechanism 64. In a similar manner, a second framework rail 80 extends the length of the longitudinal slot 72 and is configured to support an opposing end of an axle 78 supporting a conveyance mechanism 64. In a similar manner, each of the plurality of conveyance mechanisms 64 has a supporting axle 78 connected at one end to the first framework rail 76 and at an opposing end to a second framework rail 80.

Referring again to FIG. 5, each of the conveyance mechanisms 64 has an outer surface 82. An uppermost point 84 of the outer surface 82 of each of the conveyance mechanisms 64 is positioned below the upper surface 22 of the deck assembly 20 a distance d1. The distance d1 is configured such that the upper portions of the first and second framework rails 76, 80 guide the wheels 48 of the recovered vehicle 46 in a manner such that the wheels 48 are retained within the longitudinal slot 70 as the recovered vehicle 46 is pulled forward and loaded onto the deck assembly 20 or offloaded from the deck assembly 20. In the illustrated embodiment, the distance d1 is in a range of from about 0.25 inches to about 2.00 inches. In alternate embodiments, the distance d1 can be less than about 0.25 inches or more than about 2.00 inches sufficient to guide the wheels 48 of the recovered vehicle 46 in a manner such that the wheels 48 are retained within the longitudinal slot 70 as the recovered vehicle is pulled forward and loaded onto the deck assembly 20 or offloaded from the deck assembly 20.

The conveyance mechanisms 64 illustrated in FIGS. 4 and 5 have the form of rotatable rollers. Each of the rollers 64 has a diameter D and a length L. The diameter D and the length L are configured to facilitate movement of the recovered vehicle wheels along the deck assembly 20. In the illustrated embodiment, the diameter D is in a range of about 1.0 inches to about 4.0 inches and the length L is in a range of from about 8.0 inches to about 14.0 inches. However, it should be appreciated that in other embodiments, the diameter D can be less than about 1.0 inches or more than about 4.0 inches and the length L can be less than about 8.0 inches or more than about 14.0 inches, sufficient to facilitate movement of the recovered vehicle wheels along the deck assembly 20.

However, it should be appreciated that in other embodiments, the conveyance mechanisms 64 can have other forms and can be other structures, mechanisms, and devices. As one non-limiting example, the plurality of conveyance mechanisms 64 can have the form of a plurality of rotatable, spaced apart wheels. In a manner similar to the rotatable rollers, the rotatable, spaced apart wheels can be mounted on axles positioned within the longitudinal slots 70 and can be configured to facilitate movement of the recovered vehicle 46 along the deck assembly 20 in a direction toward, or away from, the headboard frame 30 in the event the wheels 48 of the recovered vehicle 46 may not rotate or experience difficulty rotating.

Referring again to the embodiment shown in FIGS. 4 and 5, in another non-limiting example, it is contemplated that the plurality of conveyance mechanisms 64 can have the form of a plurality of rotatable, spaced apart roller spheres. In a manner similar to the rotatable rollers, the rotatable, spaced apart roller spheres can be mounted within the longitudinal slots 70 and can be configured to facilitate movement of the recovered vehicle 46 along the deck assembly in a direction toward, or away from, the headboard frame 30 in the event the wheels 48 of the recovered vehicle 46 may not rotate or experience difficulty rotating.

While each of the plurality of conveyance mechanisms 64 illustrated in FIGS. 4 and 5 have the same form, it is contemplated that in other embodiments, conveyance mechanisms having different forms can be combined in a single conveyance assembly. As one non-limiting example, it is contemplated that a single conveyance assembly can include a plurality of rotatable roller-based conveyance mechanisms, a plurality of rotatable, spaced apart wheels and a plurality of rotatable, spaced apart roller spheres, arranged in a manner sufficient to facilitate movement of the recovered vehicle 46 along the deck assembly in a direction toward, or away from, the headboard frame 30 in the event the wheels 48 of the recovered vehicle 46 may not rotate or experience difficulty rotating.

Referring again to the embodiment shown in FIG. 4, each of the first and second conveyance assemblies 60, 62 extend from the first end 32 of the deck assembly 20 to the second end 36 of the deck assembly 20 in a continuous manner. It should be appreciated that in other embodiments, the first and second conveyance assemblies 60, 62 can extend from the first end 32 of the deck assembly 20 to the second end 36 of the deck assembly 20 in a discontinuous manner, meaning each of the first and second conveyance assemblies 60, 62 can be formed from a plurality of separate and discrete conveyance assemblies.

Referring again to the embodiment shown in FIG. 4, the conveyance mechanisms 64 forming the plurality of conveyance assemblies 60, 62 are arranged in single file columns. In alternate embodiments, the conveyance mechanisms 64 forming the plurality of conveyance assemblies 60, 62 can be arranged in any desired manner, including the non-limiting example of random arrangements.

Referring again to the embodiment shown in FIG. 4, the deck assembly 20 includes a quantity of two (2) conveyance assemblies 60, 62. It is contemplated that in alternate embodiments, more than two conveyance assemblies 60, 62 can be used. As one non-limiting example, in certain embodiments, a third conveyance assembly can be positioned between the first and second conveyance assemblies 60, 62 and configured for recovered vehicles having a third wheel. In a manner similar to the two conveyance assemblies 60, 62, the third conveyance assembly is configured to facilitate movement of the third wheel of the recovered vehicle 46 along the deck assembly in a direction toward, or away from, the headboard frame 30 in the event the third wheel of the recovered vehicle 46 may not rotate or experience difficulty rotating. Non-limiting examples of recovered vehicles having three wheels is a vintage Morgan 3-Wheeler produced by the Morgan Sports Car Company, the vintage Robin produced by Reliant, the vintage Dale produced by the Twentieth Century Motor Car Corporation, the Smart produced by the Daimler City Car brand and the like.

While the embodiment of the deck assembly 20 shown in FIG. 5 illustrates the uppermost point 84 of the outer surface 82 of the conveyance mechanism 64 as being positioned below the upper surface 22 of the deck assembly 20, in alternate embodiments, the conveyance mechanism 64 can have other arrangement relative to the upper surface 22 of the deck assembly 20. Referring now to FIG. 6, another embodiment of a deck assembly 120 is illustrated. The alternate deck assembly 120 includes an upper surface 122, a lower surface 124 and a deck body 126. A longitudinal slot 170 is formed in the upper surface 122 and the deck body 126. The longitudinal slot 170 extends from a first end of the deck assembly 120 to a second end of the deck assembly 120 and forms a first slot side 172 and a second side 174. A first framework rail 176 extends the length of the longitudinal slot 170 and is configured to support an end of an axle 178 supporting a conveyance mechanism 164. In a similar manner, a second framework rail 180 extends the length of the longitudinal slot 172 and is configured to support an opposing end of the axle 178 supporting the conveyance mechanism 164. In a similar manner, each of the plurality of conveyance mechanisms 164 has a supporting axle 178 connected at one end to the first framework rail 176 and at an opposing end to a second framework rail 180.

Referring again to FIG. 6, an upper portion of the first framework rail 176 includes an angled extension member 190. In a similar manner, an upper portion of the second framework rail 180 includes an angled extension member 192. The angled extension members 190, 192 are configured to guide the wheels of the recovered vehicle in a manner such that the wheels are retained within the longitudinal slot 170 as the recovered vehicle is pulled forward and loaded onto the deck assembly 120 or offloaded from the deck assembly 120.

Referring again to FIG. 6, each of the conveyance mechanisms 164 has an outer surface 182. An uppermost point 184 of the outer surface 82 of each of the conveyance mechanisms 164 is positioned above the upper surface 122 of the deck assembly 120 a distance d2. The distance d2 is configured such that the angled extension members 190, 192 guide the wheels of the recovered vehicle in a manner such that the wheels are maintained on the conveyance mechanisms 164 as the recovered vehicle is pulled forward and loaded onto the deck assembly 120 or offloaded from the deck assembly 120. In the illustrated embodiment, the distance d2 is in a range of from about 0.25 inches to about 2.00 inches. In alternate embodiments, the distance d2 can be less than about 0.25 inches or more than about 2.00 inches sufficient to guide the wheels of the recovered vehicle in a manner such that the wheels are maintained on the conveyance mechanisms 164 as the vehicle is pulled forward and loaded onto the deck assembly 120 or offloaded from the deck assembly 120.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A deck assembly configured for use in a flatbed truck, the deck assembly comprising:
a deck body having an upper surface, an opposing lower surface, a first end and an opposing second end;
a plurality of longitudinal slots extending from the upper surface of the deck body into the deck body; and
a plurality of conveyance assemblies positioned in the longitudinal slots, each of the plurality of conveyance assemblies having a plurality of conveyance mechanisms configured to facilitate movement of a wheel of a recovered vehicle in a direction along the longitudinal slot.

2. The deck assembly of claim 1, wherein each of the longitudinal slots extends from the first end of the deck body to the second end of the deck body.

3. The deck assembly of claim 1, wherein the plurality of conveyance assemblies are arranged parallel to each other.

4. The deck assembly of claim 1, wherein each of the plurality of conveyance mechanisms has the form of a rotatable roller.

5. The deck assembly of claim 4, wherein in an installed orientation, each of the rotatable rollers has an upper surface that is below the upper surface of the deck body.

6. The deck assembly of claim 5, wherein each of the longitudinal slots has a first slot side and an opposing slot side, and wherein the first and second slot sides are configured to retain wheels of the recovered vehicle within the longitudinal slots as the recovered vehicle moves along the deck assembly.

7. The deck assembly of claim 4, wherein in an installed orientation, each of the rotatable rollers has an upper surface that is above the upper surface of the deck body.

8. The deck assembly of claim 7, wherein each of the longitudinal slots has a first extension member and an opposing second extension member, and wherein the first and second extension members are configured to maintain wheels of the recovered vehicle on the plurality of conveyance assemblies as the recovered vehicle moves along the deck assembly.

9. A method of forming a deck assembly for use in a flatbed truck, the method comprising the steps of:
forming a deck body having an upper surface, an opposing lower surface, a first end and an opposing second end;
extending a plurality of longitudinal slots from the upper surface of the deck body into the deck body; and
positioning a plurality of conveyance assemblies in the longitudinal slots, each of the plurality of conveyance assemblies having a plurality of conveyance mechanisms configured to facilitate movement of a wheel of a recovered vehicle in a direction along the longitudinal slot.

10. The method of claim 9, wherein each of the plurality of conveyance mechanisms has the form of a rotatable roller.

11. The method of claim 9, including the step of positioning an upper surface of each of the conveyance mechanisms below the upper surface of the deck body.

12. The method of claim 9, including the step of forming first and second slot sides in each of the longitudinal slots and using the first and second slot sides to retain wheels of the recovered vehicle within the longitudinal slots as the recovered vehicle moves along the deck assembly.

13. The method of claim 9, including the step of positioning an upper surface of each of the conveyance mechanisms above the upper surface of the deck body.

14. The method of claim 9, including the step of forming angled extension members that extend from first and second slot sides in each of the longitudinal slots and using the angled extension members to maintain wheels of the recovered vehicle within the longitudinal slots as the recovered vehicle moves along the deck assembly.

15. A flatbed truck configured to transport a recovered vehicle, the flatbed truck comprising:
a deck assembly supported by a vehicle frame, the deck assembly having a deck body having an upper surface, an opposing lower surface, a first end and an opposing second end, the deck body having a plurality of longitudinal slots extending from the upper surface of the deck body into the deck body; and
a plurality of conveyance assemblies positioned in the longitudinal slots, each of the plurality of conveyance assemblies having a plurality of conveyance mechanisms configured to facilitate movement of a wheel of a recovered vehicle in a direction along the longitudinal slot.

16. The flatbed truck of claim 15, wherein each of the plurality of conveyance mechanisms has the form of a rotatable roller.

17. The flatbed truck of claim 16, wherein in an installed orientation, each of the rotatable rollers has an upper surface that is below the upper surface of the deck body.

18. The flatbed truck of claim 15, wherein each of the longitudinal slots has a first slot side and an opposing slot side, and wherein the first and second slot sides are configured to retain wheels of the recovered vehicle within the longitudinal slots as the recovered vehicle moves along the deck assembly.

19. The flatbed truck of claim 16, wherein in an installed orientation, each of the rotatable rollers has an upper surface that is above the upper surface of the deck body.

20. The flatbed truck of claim 19, wherein each of the longitudinal slots has a first extension member and an opposing second extension member, and wherein the first and second extension members are configured to maintain wheels of the recovered vehicle on the plurality of conveyance assemblies as the recovered vehicle moves along the deck assembly.
